(19) United States
(12) Patent Application Publication
(10) Pub. No.: US 2010/0107507 A1
(43) Pub. Date: May 6, 2010

(54) COVER ITEM PROVIDED WITH A SEAL AND PRODUCTION METHOD THEREOF

(75) Inventor: Fabio Fiammengo, Mogliano Veneto (IT)

Correspondence Address: KATTEN MUCHIN ROSENMAN LLP, 575 MADISON AVENUE, NEW YORK, NY, 10022-2585, US

(73) Assignee: UNITEAM ITALIA SRL, Quarto d' Altino (IT)

(21) Appl. No.: 12/619,089

(22) Filed: Nov. 16, 2009

Related U.S. Application Data
(63) Continuation of application No. PCT/IT2007/000352, filed on May 16, 2007.

(51) Int. Cl. E06B 7/16; B60J 5/00; B29C 45/14

(52) U.S. Cl. 49/489.1; 296/146.1; 49/475.1; 264/274

(57) ABSTRACT

A method of production of a manufactured cover item equipped with seal includes the steps of forming a manufactured cover item using injection of plastic material into a main mold, forming anchoring means associated with the manufactured cover item and forming the seal by means of overmolding on the anchoring means.

### CROSS-REFERENCE TO RELATED APPLICATIONS

This application is a continuation of and claims priority to International Application PCT/IT2007/000352 file May 16, 2007, which was published in English and which is hereby incorporated by reference in its entirety for all purposes.

### BACKGROUND OF THE INVENTION

1. Field of the Invention

The present invention refers to a manufactured item, for example a vehicle door, equipped with a seal. The following description is made with reference to this field of application, with the goal of simplifying its illustration. The invention also refers to a method for the production of one such manufactured item.

2. Background

It is known that car doors are composed of a metal panel and a manufactured cover item, usually a paneling, on which plastic components are housed/obtained, such as for example arms, grips, handles, switch housings etc.

The manufactured cover items are applied or glued to the metal frame with the interposition of a polymer seal, obtained according to the prior art with the following methods:

(i) the seal is separately made and is applied or mounted inside a groove or slot made in the plastic manufactured item, by pressing the seal so as to obtain the sealing by means of anchoring means. The seal in this case can be made with a thermoplastic elastomer, more frequently a thermosetting elastomer, of the type used for making seals of O-ring or polyurethane foam type;

(ii) the seal, still made separately, is glued by means of glues or solvents or simply attached with adhesives on the plastic manufactured item. Also in this case, the seal is usually a thermosetting piece;

(iii) the seal, in this case a polymeric foam, is applied to the previously molded plastic manufactured item by means of a robotized plant which drips a liquid mixture in a prearranged groove by means of a mixing and metering head. The polymerization occurs at a specific time, directly on the piece, leading to the formation of the seal. The mixing head can be fixed or moved by a robot.

The above-described methods have drawbacks. They require high process times for the production of the finished composite manufactured item (i.e., for example, a car door) which comprises the panel and the internal manufactured cover item equipped with seal. Consequently, the cost associated with the production is unavoidably high. The laying of the seal is difficult, so that the resulting composite manufactured items must often be discarded. Finally, one must often employ high-cost robotized systems.

### SUMMARY OF THE INVENTION

The object of the present invention is to provide a production method of a manufactured cover item, equipped with seal, which eliminates the abovementioned problems. Such object is reached with a production method of a manufactured cover item equipped with seal comprising the steps of

forming a manufactured cover item by means of injection of plastic material into a main mold,

forming anchoring means for a seal associated with said manufactured cover item,

characterized in that it comprises the step of

forming the seal by means of overmolding over the anchoring means.

Preferably, said anchoring means are slots prearranged for receiving the material, slots obtained with the traditional methods of two-component molding.

Preferably, the molding of the seal occurs immediately after the simultaneous molding of the manufactured item and said anchoring means (for example by employing known mold part movement techniques to mold one piece on another already contained in the mold).

Also forming the object of the present invention is a manufactured item equipped with a seal characterized in that it is made according to the aforesaid method.

The invention attains the following advantages:
high production speed of the finished manufactured item and possibility of large production quantities, thus eliminating the dead times and the waiting times for pieces in storage;
the seal is obtained with classical molding methods;
highly qualified personnel are not required for the seal insertion;
there is no use of robotized system for the application of the seal;
a very high adhesion level is obtained, without using glues, adhesives or solvents and without the use of mechanical clasps;
the aesthetic aspect of the obtained seal is high-level, seal joint and slippage lines are not visible;
the system is very precise and repeatable, it does not depend on the operator;
since the seal is thermoplastic, the discards can be recovered and the material possibly recycled.

### BRIEF DESCRIPTION OF THE DRAWINGS

The characteristics and advantages of the invention will be clear from the description, made here below, of an embodiment given as indicative and non-limiting with reference to the attached drawings.

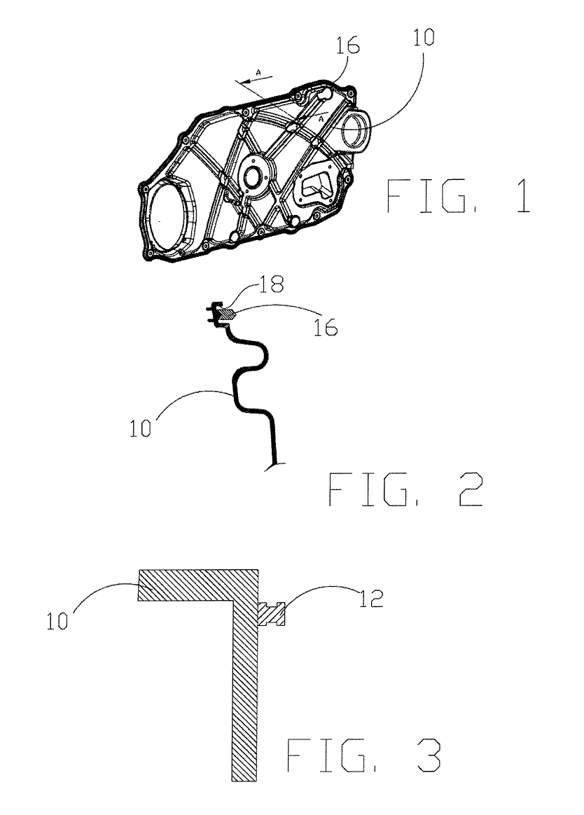

In FIG. 1 a manufactured cover item is shown equipped with seal according to the invention.

In FIG. 2 an enlarged view is shown along the surface of section A-A of FIG. 1.

In FIG. 3 a section is shown of a manufactured item according to the invention with regard to one variant.

### DETAILED DESCRIPTION OF THE INVENTION

Initially, a manufactured cover item 10 is formed (for example a vehicle door) by means of mechanical injection of a material in a prearranged mold, said main mold.

Such material is usually of thermoplastic type and/or has characteristics which allow it to easily take the shape of the mold in which it is inserted, without requiring any other manual or automated intervention.

According to the invention, anchoring means are made on the manufactured cover item 10 so as to be able to anchor a seal 16, which then permits the coupling with the metal panel not shown in the figure. Such anchoring means can be made in different modes. According to one embodiment of the invention, there can be slots 18 made on the manufactured cover item 10 which are adapted to receive the seal 16 of elastomeric material; this is the case shown in FIG. 2.

Alternatively, pins with notches 12 can be used to permit the seal 16 to be locked on the manufactured cover item 10. According to one advantageous characteristic of the invention, the step of anchoring the seal 16 to the manufactured cover item 10 by means of slots 18 or pins with notches 12 occurs during the forming of the manufactured cover item in the main mold. The seal nevertheless does not necessarily need slots or pins to be locked on the piece, since the adhesion can be ensured by the chemical-physical compatibility of the two materials—that of the seal and that of the manufactured item 10. In this case, the anchoring means consist of adequate flat or corrugated zones, prearranged to accept the plastic material which upon solidification will make up the seal. Here, the slot can serve as a guide for a subsequent mounting, to ensure a perfect coupling to the metal panel such that the seal is set therein, or for protection of the seal during the coupling.

The slots 18 can be made according to known molding techniques, such as molding with moving blades; alternatively, a translation or rotation mold can be used.

The method according to the invention permits a high production speed of the finished manufactured item (completed door), ensuring large-scale productions and attaining the above-mentioned advantages.

At the end of the mold step, the manufactured item composed of the manufactured cover item 10 and the associated seal 16 is extracted.

What is claimed is:

1. A production method for a manufactured cover item equipped with seal, the method comprising the steps of:
(a) forming a manufactured cover item by means of plastic material so as to take a shape of the mold to be inserted,
(b) forming an anchoring means associated with said manufactured cover item,
(c) forming said seal by means of overmolding over said anchoring means.

2. The method according to claim 1, wherein said forming of the manufactured cover item is carried out by means of injection of plastic material.

3. The method according to claim 1, wherein said anchoring means comprise slots in the manufactured item.

4. The method according to claim 3, wherein said slots are made with a molding process by means of moving blades.

5. The method according to claim 3, wherein said slots are made with a molding process by means of translation of mold parts.

6. The method according to claim 3, wherein said slots are made with a molding process by means of rotation of mold parts.

7. The method according to claim 1, wherein said anchoring means comprises pins with notches.

8. The method according to claim 1, wherein said seal is composed of elastomeric material.

9. The method according to claim 1, further comprising the step of extraction of the manufactured cover item together with the seal from the main mold.

10. The method according to claim 1, wherein the forming of the seal occurs immediately after the molding of the manufactured item, leaving the latter inside the mold.

11. A manufactured item for a vehicle door comprising:
a seal, the seal comprising
a shape formed by a manufactured cover item by means of plastic material so as to take a shape of the mold to be inserted,
wherein an anchoring means associated with said manufactured cover item is formed,
the seal comprises an overmolding over said anchoring means.

12. A manufactured item for a vehicle door of claim 11, wherein said forming of the manufactured cover item is carried out by means of injection of plastic material.

13. A manufactured item for a vehicle door of claim 11, wherein said anchoring means comprise slots in the manufactured item.

14. A manufactured item for a vehicle door of claim 13, wherein said slots are made with a molding process by means of moving blades.

15. A manufactured item for a vehicle door of claim 13, wherein said slots are made with a molding process by means of translation of mold parts.

16. A manufactured item for a vehicle door of claim 13, wherein said slots are made with a molding process by means of rotation of mold parts.

17. A vehicle door comprising:
a seal, the seal comprising
a shape formed by a manufactured cover item by means of plastic material so as to take a shape of the mold to be inserted,
wherein an anchoring means associated with said manufactured cover item is formed,
the seal comprises an overmolding over said anchoring means.

18. The vehicle door of claim 17, wherein said forming of the manufactured cover item is carried out by means of injection of plastic material.

19. The vehicle door of claim 17, wherein said anchoring means comprise slots.

20. The vehicle door of claim 19, wherein said slots are made with a molding process by means of moving blades.
